(19) United States
(12) Patent Application Publication
(10) Pub. No.: US 2010/0102568 A1
(43) Pub. Date: Apr. 29, 2010

(54) Electric Power Generating System Using Permanent Magent Motors

(76) Inventor: Rodolphe Juan Jacques Bonin, Tignes (FR)

Correspondence Address: Lauson & Tarver LLP, 880 Apollo Street, SUITE 301, El Segundo, CA, 90245, US

(21) Appl. No.: 12/257,272

(22) Filed: Oct. 23, 2008

(51) Int. Cl. F03D 9/02; H02K 53/00

(52) U.S. Cl. 290/55; 320/101; 415/916

(57) ABSTRACT

A system for generating electric power. The system comprising a first rechargeable battery, a first permanent magnet motor powered by the first rechargeable battery, a device for controlling battery power to the magnet motors, a first device for converting mechanical output of the first permanent magnet to electrical energy, a second rechargeable battery charged by the electrical energy produced by the first device, a second device for controlling battery power applied to the second permanent magnet motor being powered by the second rechargeable battery and a second device for converting mechanical output of the second permanent magnet motor to electrical energy. The permanent magnet motors capable of producing more mechanical output for the same electrical input compared to conventional electric motors are used in the present invention. The system could use multiple devices in series and use solar panel combined with wind wheel to recharge any battery in outdoors use.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to electric power generating systems, and more particularly to a non-polluting electric power generating system that mainly uses two permanent magnet motors, at least one rechargeable battery, and at least one device for converting mechanical energy into electrical energy.

A variety of power generating systems are currently in use. Some of these systems use either liquid or gaseous fuels to generate electricity, while others store electrical energy for providing back-up power. Recent developments also aim at efficiently using natural forms of energy such as wind and solar energies to produce and store electricity. In the past several years, many improvements were made to such systems to increase their efficiencies.

U.S. Pat. No. 6,731,522 to Kawazoe discloses a power generation apparatus using a permanent-magnet generator having robust characteristics with high efficiency. The apparatus includes a permanent-magnet AC generator, a first converter for converting AC power into DC power, and a second converter for converting the DC power produced by the first converter into AC power. The first converter includes means for controlling active power of the AC power of the generator and means for controlling reactive power of the AC power of the generator, and the second converter includes means for producing the active power.

U.S. Pat. No. 4,560,916 to Yoshiyuki discloses an alternating current generator system for a car. The system includes a field coil, an armature coil having a three-phase connection to generate an AC output, a rectifying device for rectifying the AC output from the armature coil, a battery to be charged with the output of the rectifying device, a voltage controlling device, a solar battery and a switch connected between the solar battery and the battery. The switch compares the voltage from the solar battery to a threshold value and then supplies the field current from the solar battery or the battery when the voltage is above or below the threshold value, respectively. An exciting current for the field coil is supplied from a solar battery requiring no consumption of energy from an engine. As a result, much output current is obtained in comparison with the conventional generator having the same size, the size of the generator is substantially reduced and efficiency of the generator is improved.

In U.S. Pat. No. 4,412,170 to Roesel discloses a generator system for supplying electrical AC power when an external electrical AC power source fails. The system comprises a main AC generator unit capable of generating an AC potential at a selected frequency and voltage, and an AC generator connected to the main generator for generating AC at a high frequency. This high frequency AC is conveyed to a relatively small high speed motor and flywheel unit in a sealed chamber. The high speed motor has a stator armature with a power winding and an excitation coil, and a cooperating rotor of soft magnetic material. When the external electrical AC power source fails, the excitation coil is energized with high frequency AC to magnetize the layer of permanent magnet material into a pattern of north and south magnetic poles which will enable the rotational kinetic energy of the rotor and flywheel to generate high frequency AC of constant frequency in the power winding. This AC is then supplied to the auxiliary generator to cause it to function as a synchronous motor to drive the main generator.

Although several power generating systems such as the above have been developed, the primary object of the present invention is to provide a cheapest way to produce electricity compared to other systems known in the art. A further object is to provide a non-polluting, cheap, and efficient electric power generating system by mainly using at least two rechargeable battery, two power management devices, two high efficiency permanent magnet motors such as those disclosed in U.S. Pat. Nos. 4,751,486 and 5,594,289, and at least two device for converting the mechanical output of one of the permanent magnet motors into electrical energy, at least one solar panel for outdoor use. Preferred permanent magnet motors must be capable of producing maximum mechanical output using lowest energy input. The present invention can function without gas, fuel, oxygen, sunlight, gravity or wind. The embodiment of the system works in an exponential way, as it uses a magnetic motor and a generator in increasing size. Other objects of the present invention will become better understood with reference to the appended Summary, Description, and Claims.

### SUMMARY

The present invention is a cheap and non-polluting electric power generating system employing two permanent magnet motors such as those disclosed in U.S. Pat. Nos. 4,751,486 and 5,594,289. The system further includes two rechargeable batteries, a dynamo, two power management device, and an electric generator for converting mechanical energy into electrical energy.

A first rechargeable battery supplies power to a first permanent magnet motor via power management device, which then produces a mechanical output. The dynamo uses this mechanical output and converts it into electrical energy for charging a second rechargeable battery. The second rechargeable battery via power management device powers a second permanent magnet motor, which has more capacity than the first one. The mechanical output of the second permanent magnet motor is then used by the electric generator to produce electricity.

### BRIEF DESCRIPTION OF THE FIGURES

FIG. 1 is a block diagram of the electric power generating system in accordance with the present invention.

FIG. 2 is a block diagram of an alternate embodiment of the electric power generating system in accordance with the present invention.

### REFERENCE NUMERALS

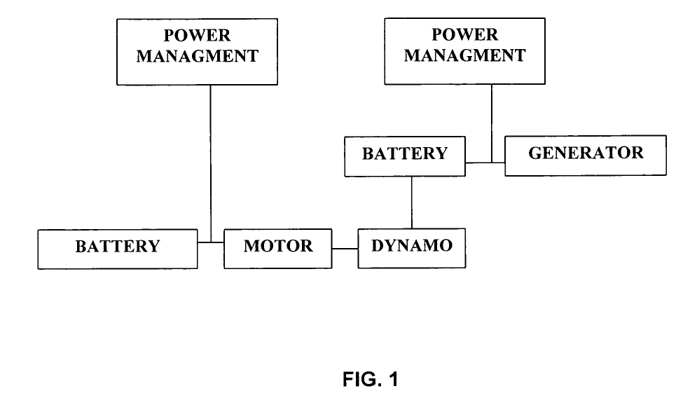

FIG. 1 is a block diagram of the generating system using a indoor system battery or fuel cell power sources.

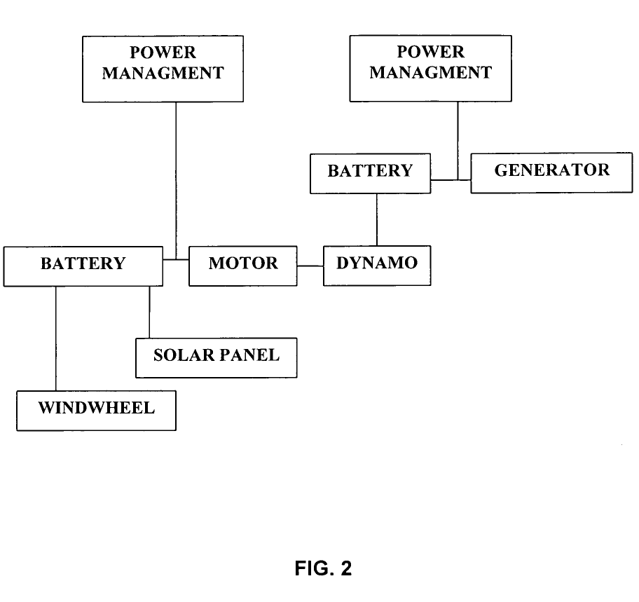

FIG. 2 is a block diagram of the generating system solar panel for outdoor use.

### DETAILED DESCRIPTION

The block diagrams of two embodiments of an electric power generating system of the present invention are shown in FIGS. 1 and 2. The preferred embodiment of the system includes two permanent magnet motors, two electric input controlling device in order to apply the right input to magnet motor. Two rechargeable batteries, a dynamo or similar device and an electric generator. The electric generator is capable of converting rotational energy to electrical energy. A solar panel and wind wheel power system can be combined for outdoor use to recharge the backup battery pack, for longer use.

The magnetic rotation apparatuses of U.S. Pat. Nos. 4,751,486 or 5,594,289 are directly employed in the present invention, and are named as the permanent magnet motors for descriptive purposes.

U.S. Pat. No. 4,751,486 discloses a magnetic rotation apparatus having first and second rotors, which are supported and connected such that they can rotate in opposite directions in a cooperating manner. The first and second rotors include same number of permanent magnets arranged on their circumferential portions at regular intervals. One of the permanent magnets of one rotor is replaced with an electromagnet, which is connected to drive circuit. The drive circuit includes a power source for supplying an electric current to coil of the electromagnet. Each permanent magnet has one magnetic polarity located radially outward from the rotors and the other magnetic polarity located radially inward toward the rotors. The radially outward polarity of each permanent magnet is identical. When the first and second rotors are rotated in a cooperating manner, the phase of rotation of the permanent magnets of one of the rotors is slightly advanced from that of the permanent magnets of the other rotor. The device also employs a controlling drive circuit, similar to that disclosed by U.S. Pat. No. 5,594,289 for minimizing the electrical input applied to each magnetic motor.

U.S. Pat. No. 4,751,486 discloses a magnetic rotating apparatus, which comprises a rotating shaft, a first rotor fixed to the rotating shaft, and a second rotor rotating along with the first rotor is also fixed to the rotating shaft. Both the first and second rotors include a plurality of permanent magnets and balancers disposed thereon. Each of the permanent magnets is obliquely arranged with respect to the radial direction line of the rotor. The apparatus further includes a first electromagnet and a second electromagnet, which are magnetically connected and disposed facing the first and second rotors, respectively, for developing a magnetic field which faces the magnetic field of the permanent magnet means of the first and second rotors. The electromagnets intermittently energized based on the rotation of the rotor. The rotating principle involved in this apparatus is similar to that specified in U.S. Pat. No. 4,751,486.

Due to the rotating principle involved in these motors, they produce more rotational energy for the same input compared to conventional electric motors. For more details, refer to U.S. Pat. Nos. 4,751,486 and 5,594,289.

Referring to FIG. 1, in a first embodiment of the present invention, a first rechargeable battery is connected via power management device to an provides power to a first permanent magnet motor, which then produces a mechanical output in the form of rotation of a shaft connected to its rotor. The dynamo connected to the first permanent magnet motor uses this mechanical output and converts it into electrical energy for charging a second rechargeable battery having more capacity than the first rechargeable battery. The second rechargeable battery is connected via power management device to and supplies power to a second permanent magnet motor. The second permanent magnet motor is selected to have more capacity than the first permanent magnet motor. The mechanical output of the second permanent magnet motor is used by the electric generator to produce electricity.

Referring to FIG. 2, an alternate embodiment of outdoors use of the present invention is similar to the first embodiment, except that the first rechargeable battery has a solar panel and/or a windwheel can be combined as well. To recharge the backup battery pack for longer use, and be cost efficient.

The permanent magnet motors are capable of producing more mechanical output compared to conventional electric motors. Specifically, the permanent magnet motors are capable of producing more rotations on their output shafts connected to rotors for the same electrical input. This capability is harnessed by the system of the present invention, which utilizes the mechanical output of the permanent magnet motors. The electric generator and also the dynamo use the additional shaft rotations achieved by the permanent magnet motors and produce additional electrical energy. The power supply to the motor is controlled by an electric management device. Specially the low input needed for the magnet motor to operate make the system cost efficient.

Conventional dynamos or similar devices converting mechanical energy into electrical energy can be used with the present invention. High efficiency rechargeable batteries such as lithium batteries or fuel cell are used in the system for better performance. The duration of power supply depends on the capacities of these batteries. However, a user can carry multiple rechargeable battery packs and can replace them after they are discharged. Additionally, in the case of outdoor use a solar panel is use to recharge the backup battery packs, and/or can been combined with wind wheel to recharge the first battery powering the first motor which minimize the cost of the recharging the system for creating electric energy, providing a very cost efficient system in outdoor mode.

In addition to outdoor usage, the power generating system is also suitable for indoors since it does not use any liquid or gaseous fuels and is less noisy compared to conventional electric generators. The system can also function in isolated and confined environments.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An electric power generating system, the system using permanent magnet motors that mainly include a rotor or two rotors, a plurality of permanent magnets disposed around the periphery of the rotor(s), and an electromagnet in the case of a single rotor or two electromagnets in the case of two rotors, the permanent magnet motors producing more mechanical output for the same electrical input compared to conventional electric motors, the system comprising:
(a) a first rechargeable battery;
(b) a first permanent magnet motor being powered by the first rechargeable battery;
(c) a first device for converting mechanical energy into electrical energy, the first device being connected to the first permanent magnet for converting mechanical output of the first permanent magnet motor to electrical energy;
(d) a second rechargeable battery being charged by the electrical energy produced by the first device, the second rechargeable battery being larger than the first rechargeable battery;
(e) a second permanent magnet motor being powered by the second rechargeable battery, the second permanent magnet motor being larger than the first permanent magnet motor; and

2. The electric power generating system of claim 1, wherein the rechargeable batteries comprise lithium battery packs.

3. The electric power generating system of claim 1, wherein the rechargeable batteries comprise fuel cells.

4. The electric power generating system of claim 1, wherein the first and second devices comprise conventional devices that convert mechanical energy into electrical energy.

5. The electric power generating system of claim 1, wherein the first device comprises a dynamo, or turbine.

6. The electric power generating system of claim 1, wherein the second device comprises an electric generator converting mechanical energy into electrical energy.

7. The electric power generating system of claim 1, wherein a power management device controls power from the first rechargeable battery apply to the magnet motor.

8. The electric power generating system of claim 1, wherein a power management device controls power from any of the batteries or fuel cell or solar panel associated with the system. that regulate and apply power to the magnet motor.

9. The electric power generating system of claim 1, wherein a solar panel and/or combined with a wind wheel in outdoor mode is used in addition of batteries to power the first battery or recharge the battery pack.
